(19) United States
(12) Patent Application Publication
(10) Pub. No.: US 2013/0238392 A1
(43) Pub. Date: Sep. 12, 2013

(54) SYSTEMS, METHODS, APPARATUSES, AND COMPUTER PROGRAM PRODUCTS FOR FACILITATING INTERACTION AND INTERCONNECTIVITY IN A LIVE ENTERTAINMENT SETTING

(71) Applicant: FREQUENCY INC., Dallas, TX (US)

(72) Inventors: Michael Jordan Sloan, Dallas, TX (US); Nathan Maxwell Stool, Dallas, TX (US)

(73) Assignee: FREQUENCY INC., Dallas, TX (US)

(21) Appl. No.: 13/788,777

(22) Filed: Mar. 7, 2013

Related U.S. Application Data
(60) Provisional application No. 61/607,815, filed on Mar. 7, 2012.

(51) Int. Cl. G06Q 30/02; G06Q 50/00

(52) U.S. Cl. CPC G06Q 30/0201; G06Q 50/01
USPC 705/7.29

(57) ABSTRACT

Systems, methods, apparatuses and computer program products are provided herein for facilitating interaction and interconnectivity in a live entertainment setting. In this regard, in some example embodiments, users (e.g., attendees of live entertainment events) are provided with a credential object, which may contain a readable indication uniquely identifying a user, such as a near field communication (NFC), radio frequency identification (RFID) tag, bar code, or the like that may be used to facilitate an interactive experience for a user, collect information about the user and the user's social media network, and/or provide interconnectivity between multiple users. The credential object may take any of a variety of forms, such as, by way of non-limiting example, a name tag, ticket, badge, wrist band, mobile device or other object in which an RFID tag may be embedded. The user is incentivized through virtual or real rewards to use the credential object in connection with, for example, participation in specific activities, purchase of products, or fulfilling an objective associated with an event.

### TECHNOLOGICAL FIELD

Embodiments of the present invention relate generally to computer-provided services and, more particularly, relate to systems, methods, apparatuses, and computer program products for facilitating interaction and interconnectivity in a live entertainment setting.

### BACKGROUND

Consumers commonly attend a wide variety of spectator and live entertainment events. These events, which range from conventions to sporting events in arenas and stadiums to large outdoor concerts, commonly attract thousands or even tens of thousands of attendees. However, currently, there is little to no interconnectivity amongst attendees of live entertainment events, or amongst attendees and their social media network. There also is no incentive for participants to provide attendance, demographic and/or personal information to event sponsors or vendors, and no easy means for sponsors and vendors to collect such information from attendees and attendees' social media network.

### BRIEF SUMMARY OF EXAMPLE EMBODIMENTS

Systems, methods, apparatuses and computer program products are provided herein for facilitating interaction and interconnectivity in a live entertainment setting. In this regard, in some example embodiments, users (e.g., attendees of live entertainment events) are provided with a credential object, which may contain a readable indication of an identity uniquely identifying a user, such as a near field communication (NFC), radio frequency identification (RFID) tag, bar code, or the like that uniquely identifies the user and that may be used to facilitate an interactive experience for a user and/or provide interconnectivity between multiple users. The credential object may take any of a variety of forms, such as, by way of non-limiting example, a name tag, ticket, badge, wrist band, or other object in which an RFID tag may be embedded.

The credential objects are used in some example embodiments to track activity of an attendee at an event. In this regard, some example embodiments provide one or more check-in points on location at an entertainment event. The check-in points may include an NFC tag, NFC device, RFID reader, bar code reader, and/or the like, which may be configured to read the NFC tag, NFC device, RFID tag, bar code, or the like embedded in a user's credential object. A user may accordingly check-in at a check-in point when performing an interactive activity at an event, visiting a particular location, such as a sponsor kiosk, at the event, and/or the like. As such, an attendee's activity at an event may be tracked.

Some example embodiments provide an activation and reward system. In this regard, in some example embodiments, a user registers, such as on-site at an event or from a remote location prior to attending the event, and receives a credential object tied to the user's registration. Registration may, for example, include providing user demographic information, completing a sponsor survey, granting access to publish information to the user's social media account(s), and/or the like. The credential object may be pre-activated, or may be activated by the user through a further step, such as checking in to a credential activation point on site at an event. In embodiments in which a user has to activate a credential object, activation may, for example, include completing an event sponsor survey in addition to activating the RFID tag in the credential object. In some example embodiments, after activation, a user accumulates points, rewards, promotional offers, and/or the like by participating in activities, completing sponsored activities, which may be verified by checking in to a check-in point on-site with the user's credential object. In this embodiment, users are incentivized through the accumulation of points, awards and/or through associated games to, for example, visit multiple destinations within an event, provide additional information to sponsors or vendors, or attend multiple events.

In some example embodiments, a user's participation in activities at an entertainment event may be tied to the user's social media account(s). In this regard, in some example embodiments, registration may include registration of a user's social media account(s), such as Facebook®, Twitter®, Google+®, LinkedIn®, Foursquare®, a proprietary social media network, and/or other social media network. Accordingly, when a user attends an entertainment event, participates in an on-site activity, and/or otherwise checks in to a check-in point at an event or at a location apart from but associated with an event, the activity may be published to the user's social media so that the user's friends and contacts may see the user's activities, including activities associated with a particular event, vendor, or sponsor. Some example embodiments providing a social media tie-in further enable a user to see a list of others who have earned reward points, attended entertainment events, participated in activities at entertainment events, and/or the like. Additional example embodiments providing a social media tie-in further enable a user to take photographs with their mobile device and post photographs to the user's social media account.

Some example embodiments provide a web portal by which a user may register to receive a credential object, register a credential object, and/or the like. The web portal of some example embodiments enables a user to view his or her accumulated reward points, event attendance history, history of participation in activities at events as verified through check-ins at check-in points, and/or the like. A user could also take photographs with their mobile device and post photographs to the web portal.

Some example embodiments provide a mobile device software application by which a user may register to receive a credential object, register a credential object, and/or the like. The mobile device software application of some example embodiments enables a user to view his or her accumulated reward points, event attendance history, history of participation in activities at events as verified through check-ins at check-in points, and/or the like. A user could also take photographs with their mobile device and post photographs to their social media account, post photographs to the website associated with the event, or send photographs to other users that are registered for the event or are connected via a social media account.

Some example embodiments enable event sponsors to create custom surveys, view what users have checked in to certain events, view what users have checked in to particular activities at events, and/or the like. Accordingly, sponsors may collect data about user interests, preferences, and/or the like that may be leveraged to facilitate enhanced targeted advertising opportunities based on known user interests. Further, some example embodiments including social media tie-ins provide sponsors with frictionless advertising opportunities across a user's social network as the user checks in to an event, participates in activities at an event, visits a sponsor kiosk at an event, and/or the like. Such embodiments may also provide sponsors access to attendees' social media contacts that are not in attendance at the event.

Some example embodiments enable event sponsors to take photographs at an event, and associate photographs with a particular attendee through activation of the attendee's credential. Photographs could be posted to a web portal or on-site kiosks. Further, some example embodiments including social media tie-ins allow the event sponsor to distribute photographs to the attendee's social media contacts.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a system for facilitating interaction in a live entertainment setting according to some example embodiments;

FIG. 2 illustrates a block diagram of an apparatus in accordance with some example embodiments;

FIG. 3 illustrates a screen capture of an example dashboard interface in accordance with some example embodiments;

FIG. 4 depicts a screen capture of an example user profile interface 400 in accordance with some example embodiments of the present invention;

FIG. 5 depicts a screen capture of an example medal/achievement viewing interface 500 in accordance with some example embodiments;

FIG. 6 depicts a screen capture of a leaderboard interface 600 in accordance with some example embodiments;

FIG. 7 illustrates a flow diagram of an example method for facilitating interaction and interconnectivity in a live entertainment setting in accordance with some example embodiments;

FIG. 8 illustrates a flow diagram of an example method for registering a user with a system for facilitating interaction in a live entertainment setting according to some example embodiments;

FIG. 9 illustrates a flow diagram of an example method for processing user activity with a system for facilitating interaction in a live entertainment setting according to some example embodiments; and

FIG. 10 illustrates a flow diagram of an example method for determining an incentive value using user profile information with a system for facilitating interaction in a live entertainment setting according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

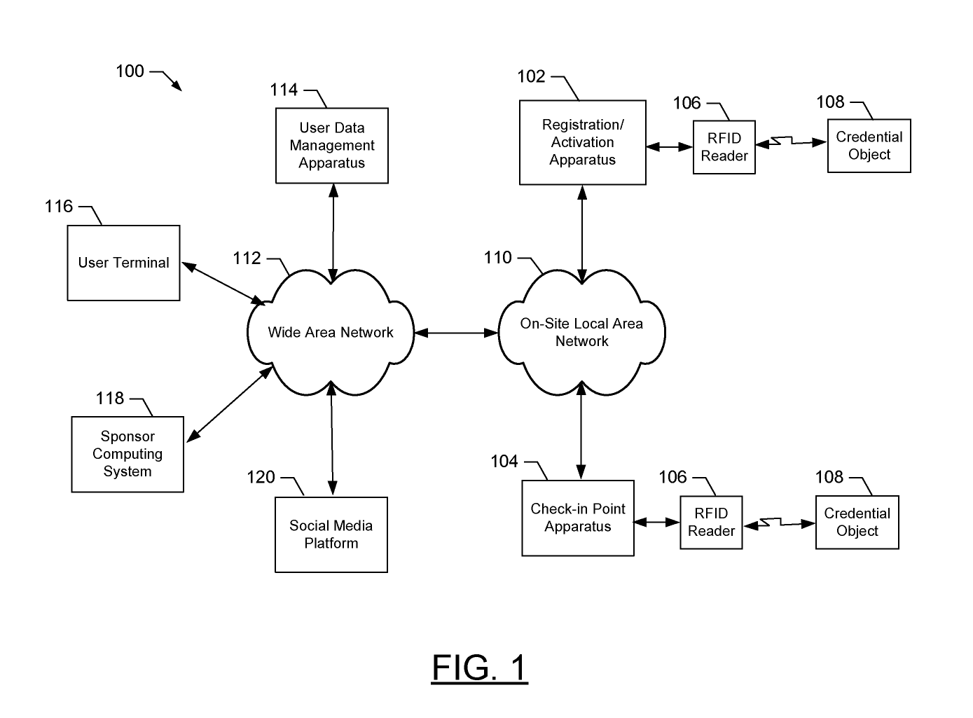

FIG. 1 illustrates a system 100 for facilitating interaction in a live entertainment setting according to some example embodiments. It will be appreciated that the system 100 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for facilitating interaction in a live entertainment setting, numerous other configurations may also be used to implement embodiments of the present invention.

The system 100 may include a network of one or more computing devices that may be implemented on-site at an entertainment event, such as a sporting event, concert, theatre event, and/or the like. In this regard, aspects of the system 100, such as the registration/activation apparatus 102, check-in point apparatus 104, RFID reader 106, on-site local area network, and/or the like may be deployed in an arena, stadium, theatre, concert hall, in an outdoor area hosting an event, and/or other venue in which an entertainment event may be hosted.

The registration/activation apparatus 102 may comprise any computing device, such as a personal computer, laptop computer, computing kiosk, or the like by which a user may register on-site at an event and/or activate a credential object 108. In this regard, the registration/activation apparatus 102 may provide a user interface enabling a user to provide demographic information in order to register to the system 100. In some example embodiments, the registration/activation apparatus 102 may be configured to locally store and/or to access a remotely stored (e.g., on the user data management apparatus 114) database of registered users.

The registration/activation apparatus 102 may comprise and/or be operatively coupled to an RFID reader 106 to enable reading of an RFID tag in the credential object 108. Accordingly, a user may check-in to an event by presenting his or her activated credential object 108 within range of the RFID reader 106. A credential object 108 may comprise any medium in which an RFID tag or other identification device may be embedded or incorporated, such as, a name tag, ticket, wrist band, or other object. A credential object may also comprise a mobile telecommunication or other portable computing device that includes technology capable of tracking tags and/or other mobile devices, for example, near field communication technology.

In some example embodiments, one or more check-in point apparatuses 104 may be deployed on-site at an event. In this regard, check-in point apparatuses 104 may be deployed throughout a sporting arena, in various locations at an outdoor concert festival, and/or the like. By way of example, a check-in point apparatus 104 may be deployed at an activity station, a sponsor kiosk, a concession or souvenir point-of-sale, and/or other location at an event at which a user may check-in by presenting his or her credential object 108 to an RFID reader 106 that may be integrated into and/or operatively coupled to a check-in point apparatus 104. By way of non-limiting example, a check-in point apparatus 104 may be embodied as a personal computer, laptop computer, computing kiosk, dedicated RFID reader, NFC reader or device and/or the like. It will be appreciated, however, that the RFID readers 106 are illustrated in FIG. 1 by way of example, and not by way of limitation, as any type of identity reader, such as a bar code reader, NFC readers and/or the like, may be used in addition to or in lieu of an RFID reader in accordance with various example embodiments. As such, where usage of RFID readers is described herein, it will be appreciated that bar code readers, NFC readers and/or other identity readers may be used in accordance with various example embodiments.

In some example embodiments, the check-in point apparatus 104 may be linked to another device, such as a cash register or point-of-sale. The check-in-point apparatus 104 may interface with the device to, for example, associate the credential object 108 with a particular transaction, such as a purchase.

In some example embodiments, computing devices that may be deployed on-site at an entertainment event may be configured to communicate over a network. For example, in some example embodiments, computing devices such as a registration/activation apparatus 102, check-in point apparatus 104, and/or other computing devices that may be deployed on-site at an entertainment event in accordance with various example embodiments may be configured to communicate over an on-site local area network 110. An on-site local area network 110 may, for example, be embodied as a wireless local area network, wired local area network, some combination thereof, and/or the like.

In some example embodiments, the on-site local area network 110 may be coupled, such as via a router, bridge, and/or other interface to a wide area network 112. The wide area network 112 may comprise a wireline network, wireless network (e.g., a cellular network, wireless wide area network, some combination thereof, or the like), or a combination thereof, and in some example embodiments comprises at least a portion of the Internet.

In some example embodiments, computing devices deployed on site at an event may be directly coupled with the wide area network 112 rather than to the on-site local area network 110. In such example embodiments, the on-site local area network may be eliminated.

A user data management apparatus 114 may be coupled to the wide area network 112 in some example embodiments. The user data management apparatus 114 may, for example, be embodied as one or more desktop computers, one or more laptop computers, one or more workstations, one or more network nodes, one or more servers, a server cluster, a cloud computing infrastructure, multiple computing devices in communication with each other, any combination thereof, and/or the like. In some example embodiments, the user data management apparatus 114 may serve as a repository for collection of user data that may be captured when a user presents his or her credential object 108 to an RFID reader 106 at an event. In this regard, the user data management apparatus 114 may be configured to maintain and store a database correlating a registered user to captured information related to his or her history of event attendance, check-ins at events, participation in activities at events, and/or other information that may be captured through the user's use of a credential object 108 registered to the user. In some example embodiments, the user data management apparatus 114 may be configured to track a user's accumulated reward points, such as may be obtained through user check-ins to a check-in point apparatus 104 and/or registration/activation apparatus 102 at an event.

The user data management apparatus 114 of some example embodiments may be configured to analyze this captured information to derive user trends, preferences, and/or other data. The results of this analysis may, for example, be provided to sponsors (e.g., advertisers) of events, which may use the analyzed data to provide targeted advertising, develop consumer promotion efforts, and/or the like. In some example embodiments, a sponsor may utilize a sponsor computing system 118, which may be configured to communicate with the user data management apparatus 114 via the wide area network 112 to access collected user data.

In some example embodiments, the user data management apparatus 114 may be configured to provide a portal, such as a web site, by which a user may register, access his or her personal usage history, access his or her accumulated reward points, and/or the like. In such example embodiments, a user may access services that may be offered by a portal that may be provided by the user data management apparatus 114 by way of a user terminal 116. A user terminal 116 may comprise any computing device that may be configured to access the wide area network 112 to access a portal that may be provided by the user data management apparatus 114. By way of non-limiting example, a user terminal 116 may comprise a desktop computer, laptop computer, tablet computer, mobile phone, and/or other computing device.

In some example embodiments in which social networking tie-ins are provided, the system 100 may comprise one or more social media platforms 120. A social media platform may comprise a computing system that may be operated by a social media provider, such as, Facebook®, Twitter®, Google+®, LinkedIn®, or the like. In some example embodiments, the user data management apparatus 114 may be configured to communicate with a social media platform 120 over the wide area network 112 to publish user activities at an event, such as registering to a registration/activation apparatus 102, checking in at a check-in apparatus 104, taking and posting photographs, and/or the like to the user's social media profile(s).

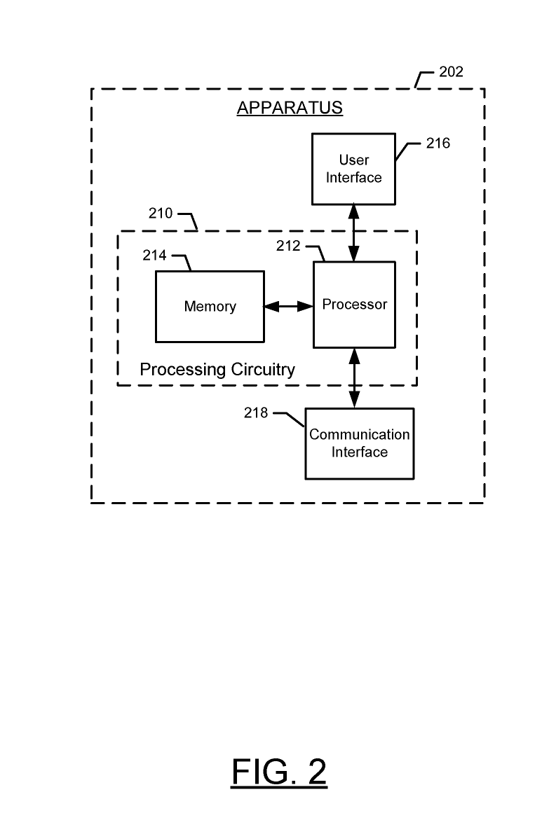

FIG. 2 illustrates a block diagram of an apparatus 202 in accordance with some example embodiments. In this regard, FIG. 2 illustrates an apparatus 202 that may be implemented on a computing device of the system 100, such as a registration/activation apparatus 102, check-in point apparatus 104, user data management apparatus 114, user terminal 116, sponsor computing system 118, social media platform 120, and/or the like to control the computing device to perform respective functionalities of the computing device. Thus, for example, in embodiments in which the apparatus 202 is implemented on the user data management apparatus 114, the apparatus 202 may control performance of functionalities attributed to the user data management apparatus 114 in accordance with various example embodiments.

It should be noted that the components, devices or elements illustrated in and described with respect to FIG. 2 below may not be mandatory and thus some may be omitted in certain embodiments. Additionally, some embodiments may include further or different components, devices or elements beyond those illustrated in and described with respect to FIG. 2.

The apparatus 202 may include or otherwise be in communication with processing circuitry 210 that is configurable to perform actions in accordance with one or more example embodiments disclosed herein. In this regard, the processing circuitry 210 may be configured to perform and/or control performance of one or more functionalities of the apparatus 202 (e.g., functionalities of a computing device on which the apparatus 202 may be implemented) in accordance with various example embodiments, and thus may provide means for performing functionalities of the apparatus 202 (e.g., functionalities of a computing device on which the apparatus 202 may be implemented) in accordance with various example embodiments. The processing circuitry 210 may be configured to perform data processing, application execution and/or other processing and management services according to one or more example embodiments. In some embodiments, the apparatus 202 or a portion(s) or component(s) thereof, such as the processing circuitry 210, may be embodied as or comprise a chip or chip set. In other words, the apparatus 202 or the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 202 or the processing circuitry 210 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with or otherwise control a user interface 216 and/or a communication interface 218. As such, the processing circuitry 210 may be embodied as a circuit chip (e.g., an integrated circuit chip) configured (e.g., with hardware, software or a combination of hardware and software) to perform operations described herein.

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of the apparatus 202 as described herein. The plurality of processors may be embodied on a single computing device or distributed across a plurality of computing devices collectively configured to function as the apparatus 202. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the apparatus 202. The memory 214 may be configured to store information, data, applications, instructions and/or the like for enabling the apparatus 202 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents or data sets. Among the contents of the memory 214, applications may be stored for execution by the processor 212 in order to carry out the functionality associated with each respective application. In some cases, the memory 214 may be in communication with one or more of the processor 212, user interface 216, or communication interface 218 via a bus(es) for passing information among components of the apparatus 202.

The user interface 216 may be in communication with the processing circuitry 210 to receive an indication of a user input at the user interface 216 and/or to provide an audible, visual, mechanical or other output to the user. As such, the user interface 216 may include, for example, a keyboard, a mouse, a joystick, a display, a touch screen display, a microphone, a speaker, a Light Emitting Diode (LED), a lighting device, and/or other input/output mechanisms. In embodiments in which the apparatus 202 is implemented on a server, aspects of the user interface 216 may be limited, or the user interface 216 may even be eliminated.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable the apparatus 202 to communicate with another computing device via the on-site local area network 110 and/or via the wide area network 112. Accordingly, the communication interface 218 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, a credential object 108 comprising an RFID tag having a Unique Identification Number (UID) is assigned to a user. In accordance with various example embodiments, relative social information may be assigned to the UID, allowing a user to activate and interconnect with other users within a live entertainment setting.

In some example embodiments, user activity within an entertainment setting may be tracked, such as based on user check-ins at a registration/activation apparatus 102 and/or at a check-in point apparatus 104. In this regard, data sets may be collected that may be valuable to event sponsors, such as for marketing purposes. This captured data may, for example, be collected and maintained by the user data management apparatus 114. In some example embodiments, collected information may be dynamically split into two or more sets of data, such as the data of the activity of the user (tracking points and achievements for activating within a particular event; and 2) the data activity of the users as displayed for the event owner or leader, hence tracking user activity throughout a live entertainment venue. In some example embodiments, collected data may be processed and analyzed, such as by filtering through a unique set of data mining practices, to derive user trends, preferences, and/or other information that may be of interest to a sponsor and/or other party that may utilize collected data.

In some example embodiments, the user data management apparatus 114 may be configured to provide a content management system (CMS). The CMS may be configured to provide a portal, such as a website. The CMS website may be secured, such as by means of public key encryption (Secure Sockets Layer—SSL). Pages of the CMS website may redirect to a login screen unless the user has already logged into the system. The login uniform resource locator (URL) may be used to help with determining the theme to apply to the CMS. The user may then be redirected to a login screen with the branding of the client. In some example embodiments, in order to log into the CMS website, a user record must have already been created by a system administrator. This process of creating a user record may involve creating a new record with a unique email address and password. In addition, the administrator may assign a user role. A user can belong to one or more roles. In some example embodiments, once a user has been authenticated by their email and password, the system may set their authorization level based upon their combined roles. For instance, by way of example, a registrar would not see top-level navigation for sponsors or users, but rather would only see what parts of the site apply to them. Once authenticated and authorized, the user may be redirected to the dashboard home page.

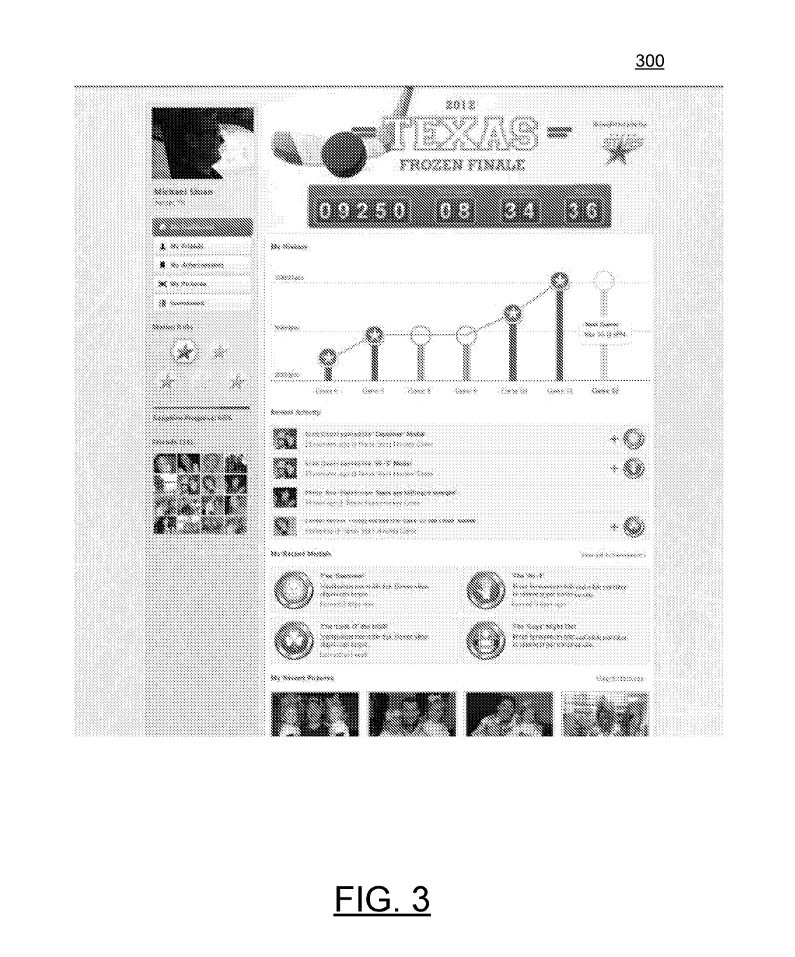

FIG. 3 depicts a screen capture of an example dashboard interface 300 in accordance with some exemplary embodiments of the present invention. The dashboard interface 300 may include an event logo, such as in the upper-left hand corner of the web page. The dashboard interface 300 may provide a home page of sorts to allow a user to interact with the system. For example, the user may be presented with the ability to view an event history (e.g., an event schedule indicating which events the user has attended), a set of recent activities (e.g., recent comments by friends of the user, recent medals earned by friends of the user, recent events attended by the user, etc.), a set of recent medals or achievements earned by the user, or the like.

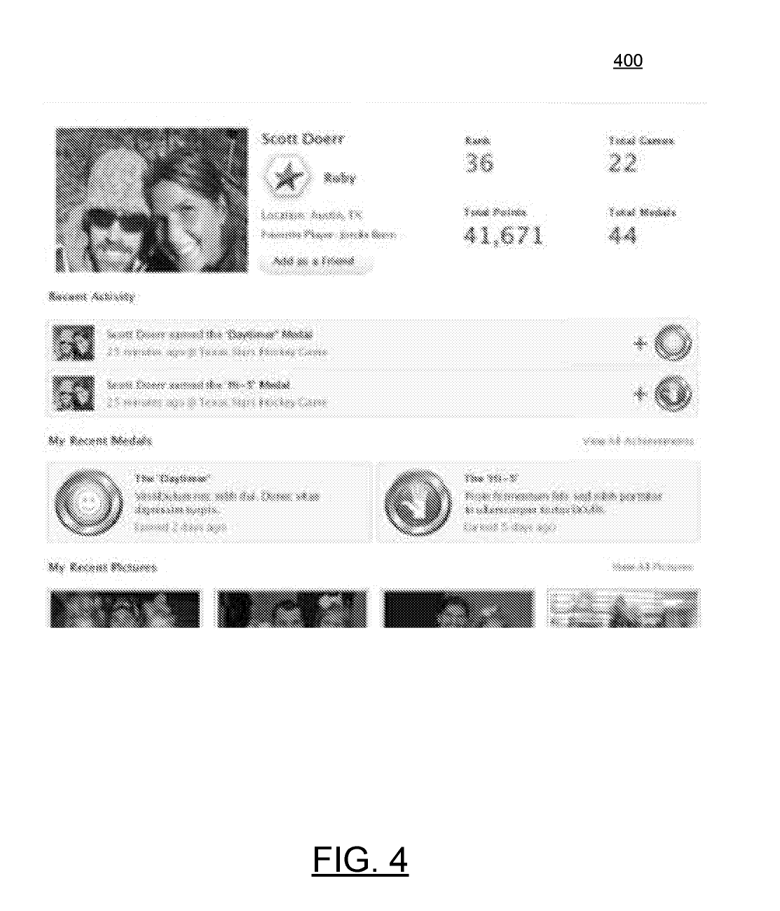

FIG. 4 depicts a screen capture of an example user profile interface 400 in accordance with some exemplary embodiments of the present invention. The user profile interface 400 may display statistics and other information about a user, such as an event user. For example, the user profile interface 400 may specify a number of points earned by the user (e.g., for earning medals or achievements), medals achieved by the user, the total number of events attended by the user, and various other data about the user. In some embodiments, the user may make their profile public so that other users can view the profile. The user may modify their profile privacy settings to, for example, restrict viewing of the profile only to certain individuals approved or identified by the user.

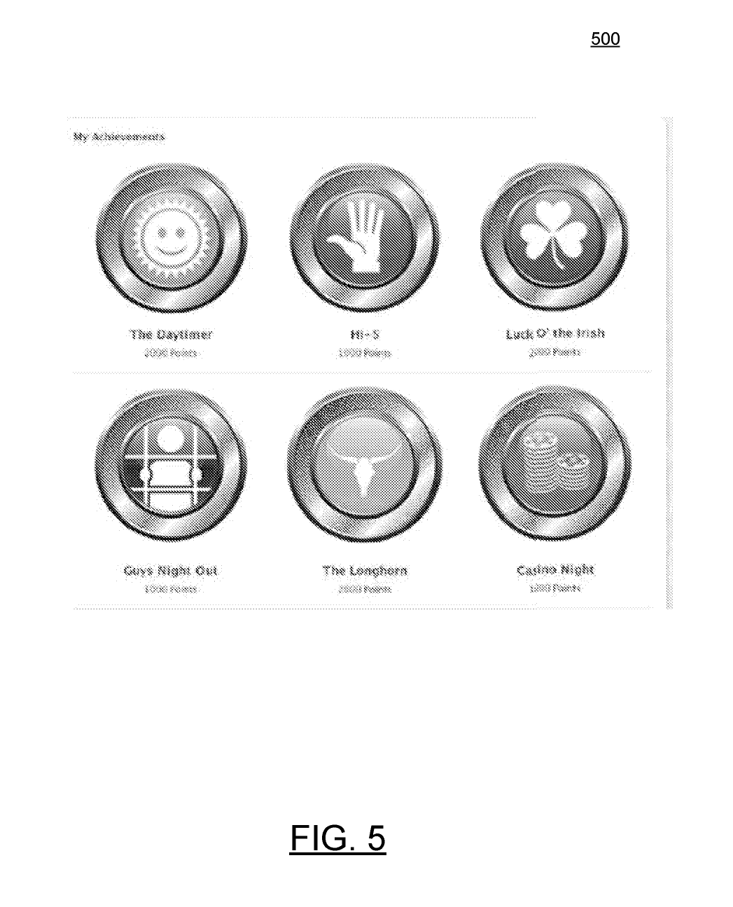

FIG. 5 depicts a screen capture of an example medal/achievement viewing interface 500 in accordance with some exemplary embodiments of the present invention. The interface 500 depicts several medals that the user has earned through their activities (e.g., by attending events, purchasing merchandise, etc.). The user may select one or more of these medals to display on their profile page or dashboard, or by various other mechanisms (e.g., association with or publication to a social networking page, such as the user's Facebook® page). Here, the user may view all of the medals or achievements previously earned. In some embodiments, the interface 500 may also display progress towards achievements or medals that the user has not yet earned.

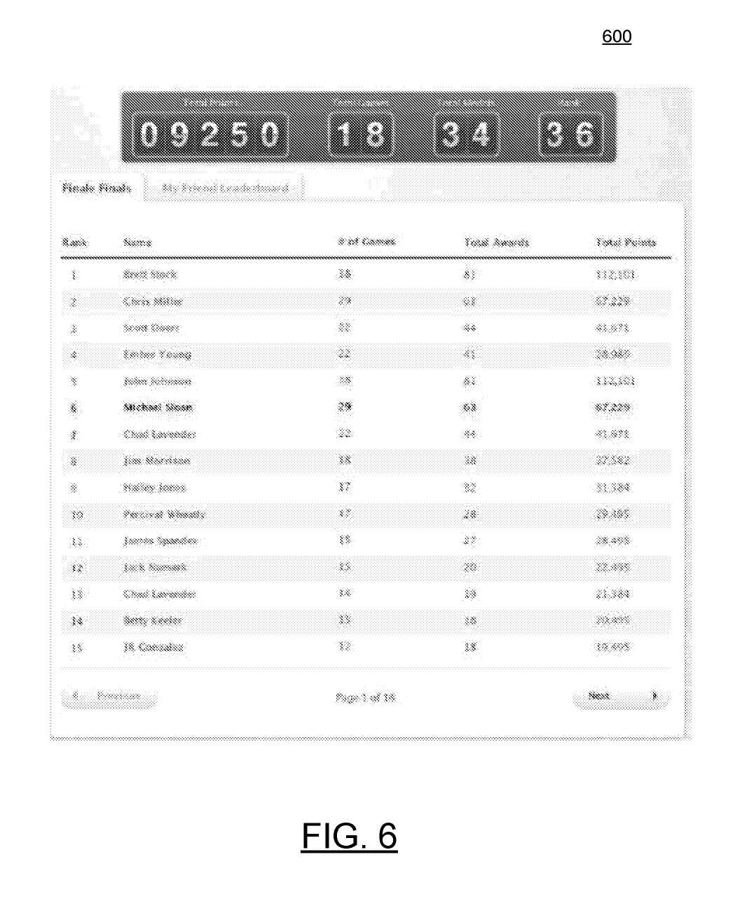

FIG. 6 depicts a screen capture of a leaderboard interface 600 in accordance with some exemplary embodiments of the present invention. The interface 600 depicts a leaderboard for users who have registered with the system to compare their score against other users. The leaderboard may provide users with the ability to compare their score/performance against all users registered with the system, or against various other groups of users. For example, the user may opt to view a leaderboard that includes only users identified or approved by the user. Additional or alternative leaderboards may also be provided. For example, users for a particular team may be able to view their aggregate performance and scores compared to the aggregate scores and performance of users associated with another team. In this manner, the system may provide users with the ability to track their performance against other users, thus fostering competition and further participation with the system.

The system may provide an interface to allow an event sponsor to add new events, incentives, user activities, and the like. This interface may include an event management page. The event management page may display a list of one or more events associated with the sponsor. In some example embodiments, a web form to enter a new event may be provided, which may display a text field for name, a text field for keyword, a text area field for description, a “What You See Is What You Get” (WYSIWYG) text-area box for the event home page (complete with an HTML toolbar), a drop-down box to attach an existing survey, an image upload text box and select button for the theme logo, a date picker for start date and end date, a checkbox for active, a list of check boxes for associating sponsors, and/or other fields or options for facilitating creation of a new event.

Event sponsors may be registered with the system by a user with a particular management role, such as an administrator. The administrator may be provided with access to a sponsor management home page, which may display a list of sponsors. Some example embodiments provide a web form to enter a new sponsor, which may display a text field for name, a list of check boxes for associating events, and/or other fields or options for entering a new sponsor and/or designating a sponsor as sponsoring particular events. The relationship of sponsors to events may be “many to many”. In this regard, a sponsor can be part of many events, and an event can have many sponsors. To capture this relationship, some example embodiments use a linking database table.

Sponsors may also create surveys for completion by users of the system, such as customers who have registered credentials with the system. These surveys may be sent to particular users who match particular profile features as indicated by the sponsors. For example, a sponsor may wish to submit a survey to male users who are between the ages of 18 and 49. The dashboard of some example embodiments provides a surveys home page, which may display a list of created surveys. Some example embodiments provide a web form to enter a new survey, which may display a text field for name, a text area field for question, text fields for answers by default, and/or other fields or options for facilitating creation of a new survey. There may be a link beside a Question text area field for removing the Question and its associated answers. Multiple Questions and answers may be managed within the same web form. On submission, the Questions and Answers may be added to the newly created survey. Some example embodiments provide for the editing of existing surveys in a substantially similar manner.

In some embodiments, the system may provide an interface for an administrator, sponsor, event owner, or the like to define the rewards, incentives, achievements, or the like that may be earned by users of the system. For example, in some embodiments, users are provided with images, achievements, “medals” or “pins” that indicate the user has completed a particular task or earned a certain number of points. The user may display these images, achievements, medals, pins, or the like on social media sites (e.g., Facebook® or Twitter®) as proof that the user has earned the particular reward.

The dashboard may provide a reward home page, which may display a list of created rewards (e.g., a list of medals, pins or achievements that may be awarded to participants in the system). Some example embodiments provide a web form to enter a new medal, which may provide a text field for name, an image upload text box, a select button for the medal image, a text box for the number of points needed to earn a medal, and/or other fields or options for facilitating the creation of a medal.

In some example embodiments, computing devices that may be used on-site at an event, such as registration/activation apparatuses 102, check-in point apparatuses 104, and/or the like, collectively referred to as “client devices” may include a user interface, such as a touch user interface, and may run custom installed client software. Client devices may be configured to work in offline mode in the event that there is no network connectivity (e.g., that there is no on-site connectivity to an on-site local area network 110 or to a wide area network 112). A client device may have its own local database store, such as a SQLite database, to which can read and write data. In some embodiments, client device data is used as a part of identification to the system. Upon successful authentication of a user of a client device, the software may determine whether the device has been setup. If the setup information is complete, the user may be redirected to the home screen which is determined by the role of the device. If the setup information is not complete, the user may be redirected to the settings screen where the user may enter in the registration information and role of the device. Roles of a client device may include activation, registration, survey, and/or the like. The client home page for a client device may be determined by the role of the device that has been established in the settings section.

If the client device's role is activation, the home screen may be the survey the user must complete, before their RFID media can be scanned.

If the client device's role is registration, the home screen may facilitate the beginning of the registration workflow. For example, a first form may be provided to gather a first name, a last name, an address, a city, a state, a zip code, an email address, a phone number, and/or the like from a participant. A second screen may provide the participant a prompt to review terms of service for using the system, and allow the system access to create a post using the participant's social media account. The form may integrate with a social media API so that the user can login and grant access. A third part of the registration workflow may capture the RFID code of a credential object that is to be given to the user. In an alternative embodiment, registration may be achieved through a participant's social media account.

If the client device's role is survey, the home screen may be the beginning of the survey workflow. The first form may gather first name, last name and email address, and/or other information. A second screen may begin the sponsor survey. The client device settings screen may allow the user to register the client device, set the default synchronization offset in minutes, manually sync the client device, establish the client device's role (e.g., activation, registration, survey, or the like). In some example embodiments, a client device application cannot be used unless it has been registered for a specific active event, sponsor, or role.

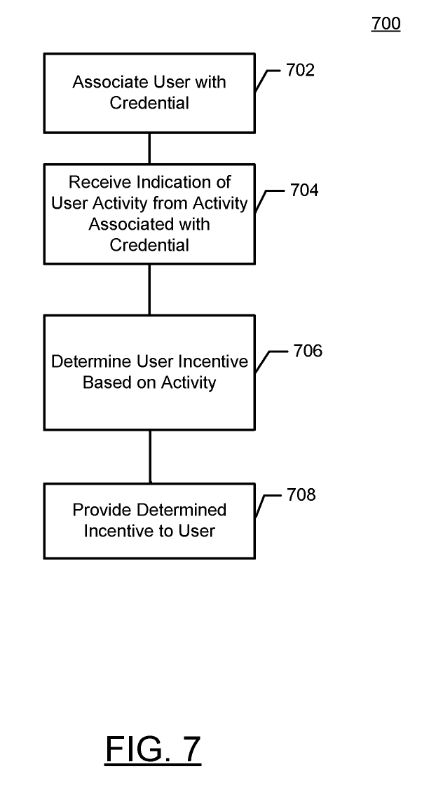

FIG. 7 illustrates a flow diagram of an example method 700 for facilitating interaction and interconnectivity in a live entertainment setting. The method 700 is operable to allow a user to provide a credential during activities, and provide incentives to the user based on the activities that are performed. These activities may also be associated with a user profile for the purposes of capturing analytical data. As described above with respect to FIG. 1, the activities may be performed in a public event setting, such as a sporting event or a concert. For example, a user may provide their credential when attending games for a particular team, when purchasing items from a souvenir stand at a sporting event for the team, when purchasing refreshments at a concession stand, or the like. As the user performs activities that are associated with the system, the user may be rewarded for these activities with incentives. For example, the user may be provided with a physical reward (e.g., a key chain, a sticker, team or band merchandise, or the like), a virtual reward (e.g., a badge, medal or pin for display on a social network page, a music file, an image file, access to a members-only web site, or the like), entry into a contest (e.g., the user may be entered into a drawing for merchandise or to meet members of a team every time they present their credential), or points that may be used to track user participation and performance. In some embodiments, the user may additionally or alternatively earn achievements based on particular criteria, and these achievements may be associated with particular rewards. The user may be rewarded with a specific badge, medal or pin for display on their social network in response to satisfying particular criteria. For example, the user may be presented with a “loyal fan” medal in response to attending three consecutive home games. Through rewards, whether the awards are real or virtual, a sponsor can drive the behavior of the participant, and incentivize the participant to participate in an activity or purchase products, such as food, drinks or merchandise.

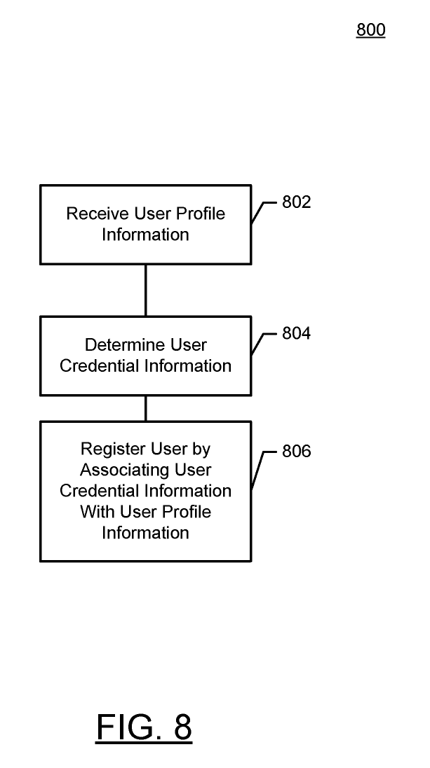

At action 702, a credential is associated with a particular user and/or user account. For example, the user may be assigned a particular RFID card, tag, or bracelet, or the user may associate a cellular phone, smart phone, or other device with a particular user account. As described above, various methods of providing a credential may be employed, including but not limited to RFID tags, NFC tags, bar codes, bar codes, Quick Recognition (QR) codes, or the like. The user may be provided with a unique credential when signing up for the system. For example, the user may be allowed to sign up for a credential at a kiosk located at the event venue. Upon providing information to the system, the user may receive a credential such as an RFID card or bracelet that is associated with the user's profile and with a unique identifier. The unique identifier may be provided by the credential in response to a challenge from a check-in system. Thereafter, the user may scan the credential when performing activities to provide the check-in system with the unique identifier, and thus link the user's profile with the activity that the user was performing. An example method for registering a user with a system for receiving activity data and providing incentives is described further below with respect to FIG. 8.

At action 704, the user's credential is scanned to indicate that the user performed a particular activity. As described above with respect to FIG. 1, the user may present the credential when performing various activities. For example, the user may scan the credential at check-in stations throughout an event venue when attending events, when purchasing refreshments or souvenirs, or the like. A system, such as the system 100, may record these check-ins in a profile associated with the user to track the user behavior and provide incentives accordingly. For example, the user may be given a particular number of points or tokens for attending a particular event. Additionally or alternatively, the user may be provided with particular incentives for performing particular tasks. For example, the user may be provided with a reward for attending a certain number of events consecutively, or spending a certain amount at a concession stand over a plurality of transactions.

At action 706, incentives are determined for the user based on the activity or activities the user has performed. Each time the user performs an activity and scans their credential, the system may record that the user performed said activity. Performance of an activity may be linked to a particular reward or point value. As the user performs activities, they may add more points to their total and/or become eligible for additional incentives. For example, users that meet particular criteria (e.g., attendance, spending levels, etc.) may be provided with rewards, such as achievements, medals or pins for display on their social networking profile. In some embodiments, rewards for meeting the particular criteria may also be associated with the award of a particular number of points or tokens. These points or tokens may be used to rank the user relative to other users. In some embodiments, these points or tokens may be used as a currency to purchase rewards from a reward shop. As described above, rewards may be physical or virtual items, entries into a contest, or the like.

At action 708, the incentives determined at action 706 are provided to the user. As the user becomes eligible for various rewards, they may receive notification from the system that they have earned said rewards. In some cases, rewards are automatically provided. For example, a given virtual reward (e.g., a pin, medal or achievement notification) may be associated with the user's profile as soon as the user meets the criteria for the virtual reward. In some embodiments, the user may manually request the incentive, such as in embodiments where the user spends points as currency to earn rewards.

Through activation and virtual rewards, the system becomes a game or contest, where participants are rewarded with electronic points, badges, pins, or similar graphical depictions of participation or achievement. Electronic rewards can be accumulated so that continued and frequent participation is associated with success in the game. The web portal of the sponsor may track the achievements of participants so that participants compete against each other to accumulate points, badges or other virtual indicia of achievement. In such a game-based embodiment, participants are incentivized to activate their credentials, for example, by taking a survey, purchasing products, visiting a kiosk or other location, or any similar activity, without actual remuneration or other direct cost to the sponsor.

FIG. 8 illustrates a flow diagram of an example method 800 for registering a user with a system for facilitating interaction in a live entertainment setting according to some example embodiments. As described above with respect to FIGS. 1 and 7, a user may generate a profile for association with the user credential in order to register the user with the system 100. The method 800 describes a process for associating a particular user with a user credential and a user profile. The method 800 may be performed by a computing device, such as the registration/activation apparatus 102 described with respect to FIG. 1.

After the user registers their credential with the system, the system may associate a unique identifier with both the user credential and the user profile such that scanning the user credential when performing an activity has the effect of indicating that the user associated with the credential performed the activity. In some embodiments, user activity histories and profile information may be used to generate analytical data describing user behavior patterns. User information may be provided according to an “opt-in” method where users indicate they are willing to provide such information for marketing purposes in exchange for use of the system 100. Information that identifies particular users may be anonymized and aggregated such that user privacy is preserved when such information is provided. User information may be provided subject to system usage terms of service and/or privacy agreements.

At action 802, user profile information is received. The user profile information may be provided by a user during a registration operation. For example, the user may fill out a web form to supply registration information (e.g., name, address, phone number), and the user may receive a user credential in response. In some embodiments, the registration process may be performed at a registration kiosk at an event venue. A user profile may be created as soon as the user submits the user information, or the user profile may be created after a user credential is determined for association with the user profile information. Registration may also be performed through a user's social media or other on-line account.

At action 804, user credential information is determined. In order to associate the user profile information with a particular credential, the system may read or scan the credential to determine a unique identifier associated with the credential. For example, when creating a user profile at a registration kiosk, the user may be provided with a membership card or bracelet. The user may be prompted to scan the membership card or bracelet to inform the system of which membership card or bracelet should be associated with the user profile. In some embodiments, the user may register with the system 100 from their own computing device (e.g., a home personal computer), and the user credential may be sent to the user via mail.

In some embodiments, the user may already possess the credential (e.g., the user may have a smart phone) and the method 800 may determine an identifier by reading or scanning the preexisting credential. For example, a system may communicate with a user's smart phone to retrieve the MAC address of the smart phone, or an identifier provided by an RFID or NFC circuit within the smart phone. In some embodiments, the method 800 may program the credential with a particular identifier, such as by writing to an RFID tag within the credential or sending a unique identifier to a smart phone that is registered as the credential.

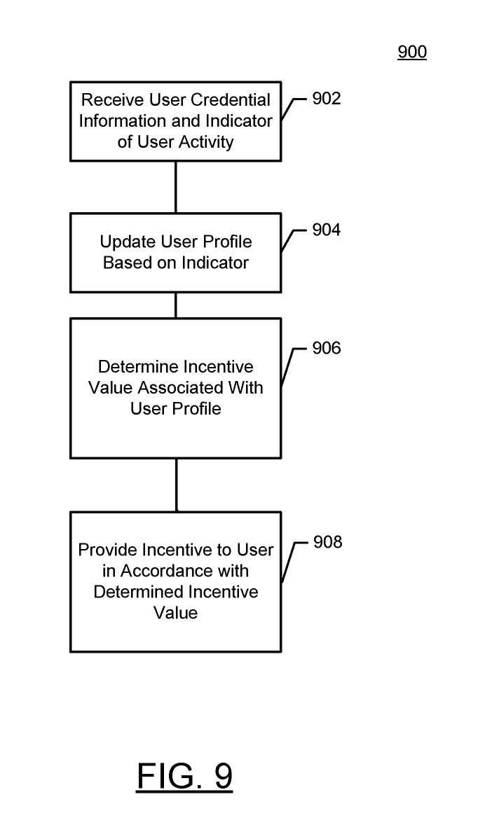

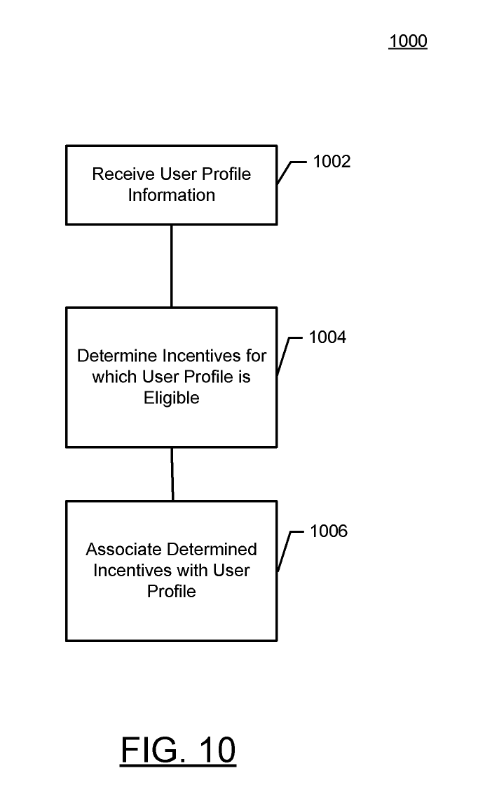

At action 806, the user profile information received at action 802 is associated with the credential information determined at action 804 to link the user profile to the credential. By linking the credential and the profile, the user may subsequently use the credential when performing an activity to record that activity with the user's profile. Thus, user activities may be recorded for the purpose of providing rewards and/or incentives for performing the activities, such as described above with respect to FIGS. 1 and 7, and below with respect to FIGS. 9 and 10.

FIG. 9 illustrates a flow diagram of an example method 900 for processing user activity with a system for facilitating interaction in a live entertainment setting according to some example embodiments. Once the user has created a profile and received a credential associated with the profile, the user may “check in” using the credential to indicate to the system that the user has performed various activities. These activities may be simple “check ins” at a particular locations or time (e.g., scanning the credential when entering the venue to indicate attendance at the event), or the activity may be associated with additional data (e.g., scanning the credential when making a purchase to register the transaction with the user profile). These activities may be used by the system to provide the user with a series of incentives and/or rewards to encourage the user to continue to participate. For example, the user may receive recognition of a high score (e.g., a public display of a points ranking), a virtual reward (e.g., an achievement, medal, badge, or pin for display on the user's social media page, a computer wallpaper, or a media file), or a physical reward (e.g., a keychain, poster, or other prize shipped to the user's home address). Different rewards and incentives may be associated with particular activity levels. For example, the user may accumulate “points” as they perform activities, and rewards may be gated at threshold point values. The method 1000 describes a process for tracking user participation and providing incentives to the user based on the tracked participation. The method 900 may be performed by a computing device such as, for example, a user data management apparatus 114 as described with respect to FIG. 1.

At action 902, user credential information and an indicator of an activity performed by the user are received. The user credential information may be determined based on the results of a scan operation performed on the user credential. For example, the user may swipe the user credential on a card reader, bring the user credential into proximity with a proximity based scanner (e.g., a RFID or NFC reader), or expose the user credential to a visual scanner (e.g., a QR or barcode reader). The indicator of the activity may be determined based on the particular reader that reads the credential. For example, a particular check-in apparatus may be associated with an entryway to the venue, and as such the user may be tagged as in attendance at the event venue in response to scanning the credential at the particular check-in apparatus. Another check-in apparatus might be associated with a concession stand, and the system may ascertain that the user is making a refreshment purchase because of this association. In some embodiments, the activity may be explicitly indicated in a message that reports the credential to the system. For example, the message may provide an identifier for the credential along with a type of activity data and any other data associated with the activity (e.g., transaction amount at the concession stand, number and type of items purchased, or the like).

At action 904, the user profile associated with the user credential may be updated with information to record the user's participation in the activity. The user profile may thus track the activities that are performed by the user so that the user may be rewarded with incentives for continuing to perform activities. As described above, the user may be credited with points or tokens in response to performance of particular activities, or the user may receive achievements in response to completing particular activities.

At action 906, an incentive may be determined for the user based on the activities that the user has performed. As described above, the user may be provided with various rewards for attendance and participation in events. As the user presents their credential during more and more activities, the user may be provided with increasing physical, virtual, or other incentives. In some embodiments, rewards are provided based on the user meeting certain criteria. The criteria may include particular user profile information (e.g., the user indicates they are a fan of a particular team) and particular activity information (e.g., the user scans their credential at a threshold number of games for the particular team). In some embodiments, different awards may be provided to different users for the same activity based on user profile information. For example, a user whose profile indicates that they are a fan of a particular team might be awarded with an “attended an away game” achievement for attending an away game for their team, while a fan with a profile that indicates a preference for the other team might be credited with an “attended a home game” achievement. In some embodiments, achievements may be associated with particular virtual rewards. For example, when earning an achievement, the user may be prompted to post the achievement to a social media web page to indicate to their social media network that they have earned said achievement. In other embodiments, posting of photographs or achievements to the user's social media network is automatic. In some embodiments, virtual currency may be awarded to the user in response to earning the achievement, with different achievements being associated with different currency values. This currency may be used to select particular incentives for the user. In other embodiments, no physical incentives are associated with the virtual achievements, thereby incentivizing the user only with virtual rewards, and without providing any monetary compensation or physical reward.

At action 908, the incentive determined at action 908 are provided to the user. Different incentive types may be associated with different delivery mechanisms. Physical incentives may be mailed directly to the user, or the user may receive the physical incentive from a reward or redemption kiosk at the event location. Virtual incentives may be provided to the user via e-mail or a special purpose application available for download on the user's personal computer or mobile device. As described above, virtual incentives that include social network recognition such as achievements, pins, or badges may be provided to the user via a prompt menu, allowing the user to select a social media network for publication of the incentive (e.g., by “sharing” a text blurb and image associated with the achievement on the user's social network home page). Other virtual incentives may be automatically loaded to a user's social media network. Other virtual incentives may be provided to the user via e-mail, or in the form of a redemption code. For example, users that reach a particular reward tier may be provided with a link to download a file, or a code to redeem on an e-commerce page to receive a media file such as a song or a video. In this manner, the method 900 may provide exclusive rewards to users of the system to encourage the user to scan their user credential when performing activities the system sponsors and/or administrators wish to incentivize.

FIG. 10 illustrates a flow diagram of an example method 1000 for determining an incentive value using user profile information with a system for facilitating interaction in a live entertainment setting according to some example embodiments. As the user performs activities and has the activities associated with their profile, the user may qualify for various awards, incentives, points, and the like. As such, the method 1000 describes an example method for determining an incentive based on recorded activity information present in the user's profile, and associating the incentive with the user's profile.

At action 1002, the system receives user profile information. The user profile information may include both user demographic information (e.g., name, address, age, phone number, team preference, or the like) and a record of activities performed by the user (e.g., the user's sporting event attendance for the current or past seasons, concession stand purchases, or the like). The system may also receive information associated with the user's social media accounts. For example, a user could provide additional information or photos through a social media account or a mobile software application. This information may be provided to an event sponsor or advertiser for purposes of analysis, or for immediate targeted advertisements to the user and the user's social media network contacts.

At action 1004, the user profile information is used to determine for which incentives the user may be eligible. Different incentives may be associated with different criteria. Some incentives may be associated with general participation criteria. For example, each activity may be associated with a particular number of “points” (e.g., attending a game is 100 points, making a purchase at a concession stand is worth 25 points, etc.), and the user may be awarded with the incentive upon reaching a particular point threshold (e.g., a “superfan” achievement for earning 10,000 points). Other incentives may be associated with specific criteria. For example, a particular achievement may be awarded for perfect attendance at home games for an entire season, or for attending an away game. The user profile information may be compared with a list of achievement criteria, such as created by an event sponsor or administrator using a dashboard system as described above with respect to FIG. 2. At action 1006, the incentives for which the user is eligible may be associated with the user's profile so that the user may receive the incentive.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for monitoring attendees of a live entertainment event, the method comprising:
receiving a set of attendee information from an attendee of the live entertainment event as part of a registration process;
creating an attendee profile based on the set of attendee information;
associating the attendee profile with a physical credential;
receiving an activity indication that the physical credential was used in conjunction with an attendee activity; and
recording the attendee activity in the attendee profile associated with the physical credential.

2. The method of claim 1, further comprising,
determining one or more incentives based on the recorded attendee activity associated with the attendee profile; and
providing the one or more incentives to the attendee.

3. The method of claim 1, further comprising,
posting a description of the attendee activity to a social media account associated with the attendee.

4. The method of claim 1, further comprising,
associating a photograph from a live entertainment event with the attendee profile;

5. The method of claim 4, further comprising,
posting the photograph to a website associated with the event.

6. The method of claim 4, further comprising,
posting the photograph to a social media account associated with the attendee.

7. The method of claim 4, wherein the photograph is taken by the attendee using a mobile device.

8. The method of claim 1, wherein the physical credential is a card, a bracelet, a tablet, a smart phone, or a cellular phone.

9. The method of claim 1, wherein the activity indication is generated in response to the physical credential providing data that indicates the attendee profile via at least one of near field communication, radio frequency identification, a bar code, or a quick recognition code.

10. The method of claim 1, wherein the registration process is performed at the live event, via a web interface, or via a social media account.

11. The method of claim 1, wherein the attendee activity is associated with a point value, and wherein a number of points according to the point value of the activity is added to the attendee profile in response to recording the attendee activity in the attendee profile.

12. The method of claim 11, wherein the points associated with the event profile may be redeemed for incentives.

13. The method of claim 1, wherein the indication is generated in response to activating the physical credential at a particular location.

14. The method of claim 13, wherein the particular location is at a site other than the live entertainment event.

15. An apparatus comprising a processor and a memory including computer program code, the memory and the computer program code configured to, with the processor, cause the apparatus to:
receive a set of attendee information from an attendee of a live entertainment event as part of a registration process;
create an attendee profile based on the set of attendee information;
associate the attendee profile with a physical credential;
receive an activity indication that the physical credential was used in conjunction with an attendee activity; and
record the attendee activity in the attendee profile associated with the physical credential.

16. The apparatus of claim 15, further configured to:
determine one or more incentives based on the recorded attendee activity associated with the attendee profile; and
provide the one or more incentives to the attendee.

17. The apparatus of claim 15, further configured to post a description of the attendee activity to a social media account associated with the attendee.

18. The apparatus of claim 15, wherein the attendee activity is associated with a point value, and wherein a number of points according to the point value of the activity is added to the attendee profile in response to recording the attendee activity in the attendee profile.

19. The apparatus of claim 15, wherein the indication is generated in response to activating the physical credential at a particular location and wherein the particular location is at a site other than the live entertainment event.

20. A computer readable storage medium comprising program instructions that, when executed by a processor, cause the processor to:
receive a set of attendee information from an attendee of a live entertainment event as part of a registration process;
create an attendee profile based on the set of attendee information;
associate the attendee profile with a physical credential;
receive an activity indication that the physical credential was used in conjunction with an attendee activity; and
record the attendee activity in the attendee profile associated with the physical credential.
